(19) United States
(12) Patent Application Publication
(10) Pub. No.: US 2007/0210485 A1
(43) Pub. Date: Sep. 13, 2007

(54) Method for manufacturing plugged honeycomb structure and plug filling jig

(75) Inventors: Tatsuhiko Hatano, Kasugai-city (JP); Akio Enomoto, Chita-gun (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/713,739

(22) Filed: Mar. 5, 2007

(30) Foreign Application Priority Data
Mar. 10, 2006 (JP) 2006-065779

(51) Int. Cl. B29C 45/14

(52) U.S. Cl. 264/259

(57) ABSTRACT

There is disclosed a method for manufacturing a plugged honeycomb structure capable of manufacturing a plugged honeycomb structure in which the plugging depth is uniform. A method for manufacturing a plugged honeycomb structure, according to the invention, includes disposing a plug filling jig 6 so that it covers the side of the periphery of one end 7a of the honeycomb structure 3 at the side where plugged cells 4a are open and its tip locates being protruded from the end surface of the one end 7a, the end surface of the side of the one end 7a is separated from the surrounding space and the one end 7a of the honeycomb structure 3 where the plug filling jig 6 is disposed is pressed onto a ceramic slurry to thus introduce the ceramic slurry into the plugged cells 4a to form plugged portions.

### BACKGROUND OF THE INVENTION

1. Field of the Invention

The present invention relates to a method for manufacturing a plugged honeycomb structure and a plug filling jig. In particular, the invention relates to a method for manufacturing a plugged honeycomb structure capable of manufacturing a plugged honeycomb structure in which the plugging depth is uniform, and a plug filling jig preferably used in such a method for manufacturing a plugged honeycomb structure.

2. Description of the Related Art

Exhaust gas emitted from internal-combustion engines such as a diesel engine or various types of combustion equipment contains a large volume of particulates (particulate matter) in which main ingredient is soot (black smoke). Particulates emitted into the atmosphere causes environmental pollution. Thus, it is a general practice that the exhaust gas channel from an internal-combustion engine mounts a filter to trap particulates.

An example of a filter used for this purpose is a honeycomb filter, as shown in FIG. 18, that utilizes a plugged honeycomb structure 28 comprising a honeycomb structure 21 formed by being partitioned in a honeycomb shape by porous partition walls 22, the honeycomb structure 21 having a plurality of cells 24 separated from each other by the partition walls and serving as fluid passageways and plugged portions 26 plugging alternately the openings of a plurality of cells 24 at one ends and at the other ends. According to the plugged honeycomb structure 28 shown in FIG. 18, by letting an exhaust gas G1 flow from an exhaust gas inflow-side end surface B into a cell 24, particulates in the exhaust gas G1 is trapped by the partition wall 22 when the exhaust gas G1 passes through the partition wall 22. It is thus possible to let a purified gas G2 where particulates have been removed flow from a purified gas outflow-side end surface C.

As a method for manufacturing a plugged honeycomb structure described above, a method has been proposed, as shown in FIG. 19, where an adhesive sheet or the like is affixed on one end surface of the honeycomb structure 21; holes are made in portions of the adhesive sheet or the like corresponding to cells 24 to be plugged by way of laser processing or the like using image processing, to thus provide a mask 25; the end surface of the honeycomb structure 21 where the mask 25 is affixed is immersed in a slurry 29 (ceramic slurry); the plugged cells of the honeycomb structure 21 are filled with the slurry to form plugged portions 26 (see FIG. 1); the same process is performed on the other end surface of the honeycomb structure 21; and the honeycomb structure 21 is dried and fired to obtain a plugged honeycomb structure (for example, refer to Patent Document 1).

[Patent Document 1] JP-A-2001-300922

### SUMMARY OF THE INVENTION

Such a conventional method for manufacturing a plugged honeycomb structure includes a problem that, as shown in FIG. 19, when the honeycomb structure 21 with the mask 25 affixed thereto is pressed onto the slurry 29, the slurry 29 stored in a container 27 or the like flows toward a portion where the resistance to the pressure is smaller, thus failing to introduce the slurry 29 into the plugged cells in a uniform depth.

The present invention has been accomplished in view of the problems with the conventional technology, and an object of the present invention is to provide a method for manufacturing a plugged honeycomb structure capable of manufacturing a plugged honeycomb structure in which the plugging depth is uniform, and a plug filling jig preferably used in such a method for manufacturing a plugged honeycomb structure.

The present invention provides the following methods for manufacturing a plugged honeycomb structure and plug filling jigs used in the methods.

[1] A method for manufacturing a plugged honeycomb structure comprising a cylindrical honeycomb structure including partition walls formed of a porous body and a large number of cells acting as fluid passageways divided and formed by said partition walls, and plugged portions plugging openings of some of said cells of said honeycomb structure, the method comprising the step of pressing one end of said honeycomb structure at the side where a plug filling jig is disposed onto a ceramic slurry to thus introduce said ceramic slurry into cells to be plugged (plugged cells) to form said plugged portions, wherein said plug filling jig is disposed by one of the steps selected from the step (A) and step (B) specified below: step (A) disposing said plug filling jig so that it covers the side of a periphery of said one end of said honeycomb structure at the side where plugged cells are open and a tip of said plug filling jig locates being protruded from an end surface of the side of said one end, to separate the end surface of the side of said one end from a surrounding space; and step (B) disposing said plug filling jig so that it covers the side of a periphery of said one end of said honeycomb structure on the side where plugged cells are open and a tip of said plug filling jig locates at the same position as an end surface of said one end, to increase an outer diameter of a portion of said honeycomb structure increase at the side of said one end.

[2] The method for manufacturing a plugged honeycomb structure according to [1], wherein said disposing said plug filling jig is carried by the step (A).

[3] The method for manufacturing a plugged honeycomb structure according to [1], wherein a cylindrical body having elasticity is used as said plug filling jig and said plug filling jig is disposed at the side of said one end of said honeycomb structure by way of the elastic force of said plug filling jig.

[4] The method for manufacturing a plugged honeycomb structure according to [1], wherein a belt-like body is used as said plug filling jig and said belt-like body is wound around said honeycomb structure at the side of said one end to arrange said plug filling jig at the side of said one end of said honeycomb structure.

[5] The method for manufacturing a plugged honeycomb structure according to any one of [1] to [4], wherein a material having rigidity so that a deformation in the radial direction of said honeycomb structure does not occur when it is pressed onto said ceramic slurry is used as said plug filling jig.

[6] The method for manufacturing a plugged honeycomb structure according to any one of claims 1 to 5, wherein said one end of said honeycomb structure is pressed onto the ceramic slurry while causing the tip of said plug filling jig to slide to the end surface of the side of said one end of said honeycomb structure.

[7] The method for manufacturing a plugged honeycomb structure according to [1], wherein said disposing said plug filling jig is carried by the step (B).

[8] The method for manufacturing a plugged honeycomb structure according to [7], wherein said plug filling jig is disposed at said one end to increase the outer diameter of a portion of said honeycomb structure at the side of said one end by a length equivalent to two thirds or more of the plugging depth of said slurry to be introduced into said plugged cells.

[9] The method for manufacturing a plugged honeycomb structure according to any one of [1] to [8], wherein said plug filling jig is disposed after a mask having holes capable of forming therein to communicate with said plugged cells is disposed.

[10] The method for manufacturing a plugged honeycomb structure according to any one of [1] to [9], wherein an unfired honeycomb structure is used as said honeycomb structure, and said plugged honeycomb structure is obtained by filling said plugged cells with said ceramic slurry, and then drying and firing it.

[11] A plug filling jig disposed at one end of a honeycomb structure at the side where plugged cells are open, and used to separate an end surface of the side of said one end of said honeycomb structure from a surrounding space and press said one end of said honeycomb structure onto a ceramic slurry to thus introduce said ceramic slurry into said plugged cells, said plug filling jig comprising: a cylindrical body having an inner diameter corresponding to a size of a periphery of said honeycomb structure having said plugged cells formed therein, wherein said plug filling jig can be mounted and fixed so as to separate the end surface of the side of said one end of said honeycomb structure from the surrounding space.

[12] A plug filling jig disposed at one end of a honeycomb structure at the side where plugged cells are open, and used to separate an end surface of said one end of said honeycomb structure from a surrounding space and press said one end of said honeycomb structure onto a ceramic slurry to thus introduce said ceramic slurry into said plugged cells, said plug filling jig comprising: a belt-like body having a length greater than a length of a periphery of said honeycomb structure and wound around the periphery of said honeycomb structure to thus allow said plug filling jig to be mounted and fixed so as to separate the end surface of the side of said one end of said honeycomb structure from a surrounding space.

[13] A plug filling jig disposed at one end of a honeycomb structure at the side where plugged cells are open, and used to increase an outer diameter of a portion of said honeycomb structure at the side of said one end and press said one end of said honeycomb structure onto a ceramic slurry to thus introduce said ceramic slurry into said plugged cells, said plug filling jig comprising: a cylindrical body having an inner diameter corresponding to a size of a periphery of said honeycomb structure having said cells to be plugged formed therein and a thickness capable of increasing an outer diameter of a portion of said honeycomb structure at the side of said one end, wherein said plug filling jig can be mounted and fixed on the side of said one end of said honeycomb structure.

According to a method for manufacturing a plugged honeycomb structure of the invention (the first and second inventions), it is possible to manufacture a plugged honeycomb structure in which the plugging depth is uniform. In addition, a plug filling jig according to the invention (the third to fifth inventions) can be preferably used in the method for manufacturing a plugged honeycomb structure according to the invention.

### BRIEF DESCRIPTION OF THE DRAWINGS

FIG. 1 is a perspective view schematically showing a plugged honeycomb structure manufactured by one embodiment of a method for manufacturing a plugged honeycomb structure according to the invention;

FIG. 2 is an explanatory view illustrating a process of introducing a ceramic slurry into plugged cell in one embodiment of the method for manufacturing a plugged honeycomb structure of the first invention, and is a cross-sectional view of the honeycomb structure, taken parallel to the axial direction;

FIG. 3 is another explanatory view illustrating a process of introducing a ceramic slurry into plugged cells in one embodiment of the method for manufacturing a plugged honeycomb structure of the first invention, and is a cross-sectional view of the honeycomb structure, taken parallel to the axial direction;

FIG. 4 is still another explanatory view illustrating a process of introducing a ceramic slurry into plugged cells in one embodiment of the method for manufacturing a plugged honeycomb structure of the first invention, and is a cross-sectional view of the honeycomb structure, taken parallel to the axial direction;

FIG. 5 is a perspective view showing an example of a plug filling jig used in one embodiment of the method for manufacturing a plugged honeycomb structure of the first invention;

FIG. 6 is a perspective view showing another example of a plug filling jig used in one embodiment of the method for manufacturing a plugged honeycomb structure of the first invention;

FIG. 7 is an explanatory view illustrating another exemplary process of introducing a ceramic slurry into plugged cells in one embodiment of the method for manufacturing a plugged honeycomb structure of the first invention, and is a cross-sectional view of the honeycomb structure, taken parallel to the axial direction;

FIG. 8 is an explanatory view illustrating another exemplary process of introducing a ceramic slurry into plugged cells in one embodiment of the method for manufacturing a plugged honeycomb structure of the second invention, and is a cross-sectional view of the honeycomb structure, taken parallel to the axial direction;

FIG. 9 is another explanatory view illustrating another exemplary process of introducing a ceramic slurry into plugged cells in one embodiment of the method for manufacturing a plugged honeycomb structure of the second invention, and is a cross-sectional view of the honeycomb structure, taken parallel to the axial direction;

FIG. 10 is another explanatory view illustrating another exemplary process of introducing a ceramic slurry into plugged cells in one embodiment of the method for manufacturing a plugged honeycomb structure of the second invention, and is a cross-sectional view of the honeycomb structure, taken parallel to the axial direction;

FIG. 11 is a perspective view showing an example of a plug filling jig used in one embodiment of the method for manufacturing a plugged honeycomb structure of the second invention;

FIG. 12 is another explanatory view illustrating another exemplary process of introducing a ceramic slurry into plugged cells in one embodiment of the method for manufacturing a plugged honeycomb structure of the second invention, and is a cross-sectional view of the honeycomb structure, taken parallel to the axial direction;

FIG. 13 is a graph showing plugging depths in the 85 cells on the diagonal line of the end surface in Example 1;

FIG. 14 is a graph showing plugging depths in the 85 cells on the diagonal line of the end surface in Comparative Example 1;

FIG. 15 is a graph showing plugging depths in the 70 cells on the diagonal line of the end surface in Example 2;

FIG. 16 is a graph showing plugging depths in the 70 cells on the diagonal line of the end surface in Example 3;

FIG. 17 is a graph showing plugging depths in the 70 cells on the diagonal line of the end surface in Comparative Example 2;

FIG. 18 is a schematic cross-sectional view showing a conventional honeycomb filter; and

FIG. 19 is an explanatory view illustrating a process of introducing a ceramic slurry into plugged cells in the conventional method for manufacturing a plugged honeycomb structure, and is a cross-sectional view of the honeycomb structure, taken parallel to the axial direction.

### DESCRIPTION OF THE PREFERRED EMBODIMENT

Embodiments of the method for manufacturing a plugged honeycomb structure and the plug filling jig according to the invention will be described, referring to the figures. The present invention is not limited to these embodiments but may be changed, modified or improved based on the knowledge of those skilled in the art without departing from the scope of the invention.

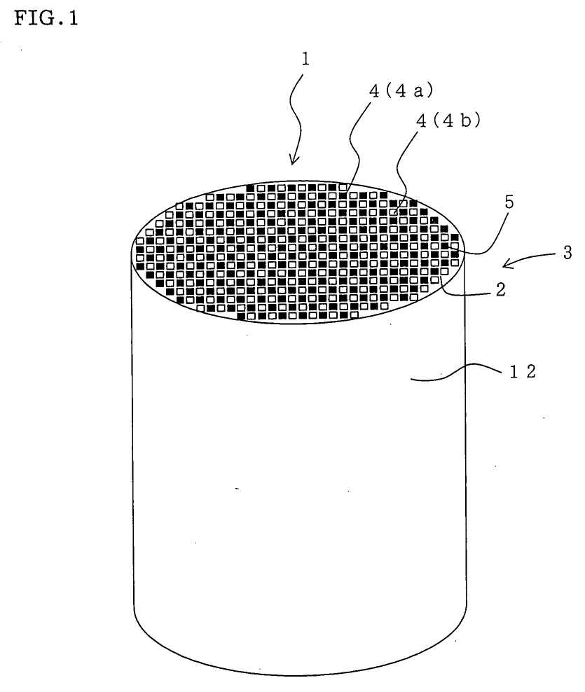

An embodiment of a method for manufacturing a plugged honeycomb structure according to the first invention will be described. FIG. 1 is a perspective view schematically showing a plugged honeycomb structure manufactured by one embodiment of the method for manufacturing a plugged honeycomb structure according to the invention. The method for manufacturing a plugged honeycomb structure according to this embodiment is a method for manufacturing a plugged honeycomb structure 1 comprising a cylindrical honeycomb structure 3 including partition walls 2 formed of a porous body and a large number of cells 4 acting as fluid passageways separated and formed by the partition walls, 2 and plugged portions 5 plugging the openings of some of the cells 4 of the honeycomb structure 3, as shown in FIG. 1.

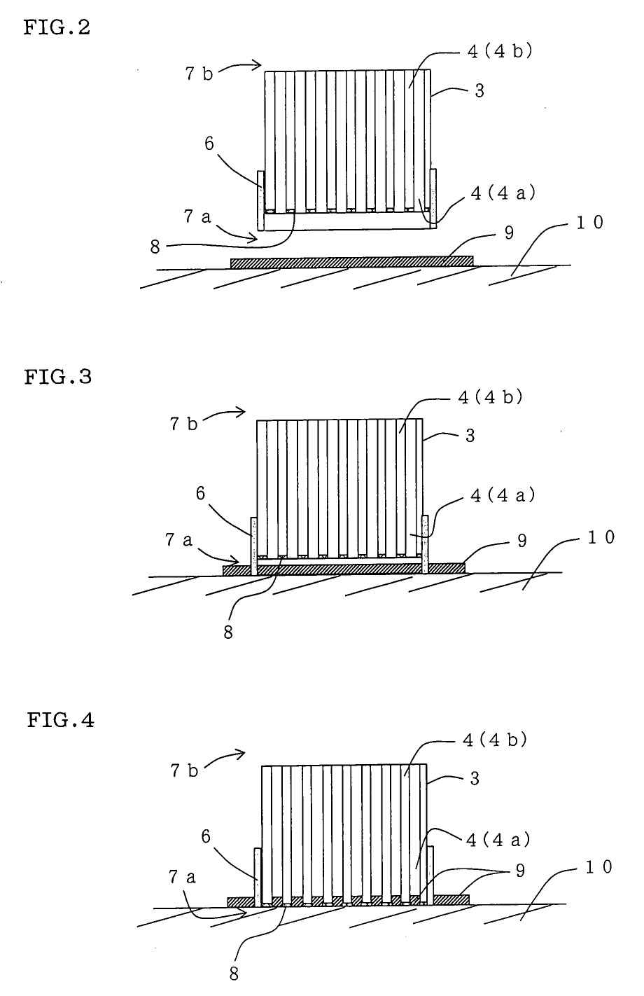

The method for manufacturing a plugged honeycomb structure according to this embodiment comprises steps of disposing, as shown in FIG. 2, a plug filling jig 6 so that it covers the side of the periphery of one end 7a of the honeycomb structure 3 on the side where plugged cells 4a are open and the tip of the plug filling jig 6 locates being protruded from the end surface of the one end 7a, to separate the end surface of the side of the one end 7a from the surrounding space, and pressing, as shown in FIGS. 3 and 4, the one end 7a of the honeycomb structure 3 where the plug filling jig 6 is disposed onto a ceramic slurry 9 to thus introduce the ceramic slurry 9 into the plugged cells 4a to form plugged portions 5 (see FIG. 1). FIGS. 2 to 4 are explanatory views illustrating a process of introducing a ceramic slurry into plugged cells in the method for manufacturing a plugged honeycomb structure according to this embodiment, and are cross-sectional views of the honeycomb structure, taken parallel to the axial direction.

With this constitution, it is possible to enclose a predetermined amount of the ceramic slurry 9 to be introduced into the plugged cells 4a in a section separated from the surrounding space on the one end 7a. It is thus possible to effectively prevent the ceramic slurry 9 to be introduced into the plugged cells 4a from flowing in the direction of the periphery from the one end 7a of the honeycomb structure 3 when the one end 7a of the honeycomb structure 3 is pressed onto the ceramic slurry 9, making it possible to introduce the ceramic slurry 9 into the plugged cells in a uniform depth.

In the method for manufacturing a plugged honeycomb structure according to this embodiment, a mask 8 having holes formed therein to communicate with the plugged cells 4a is disposed on the end surface of one end 7a of the honeycomb structure 3, so that the ceramic slurry 9 will not be introduced into the cells other than the plugged cells 4a. Any mask used in the conventional method for manufacturing a plugged honeycomb structure may be preferably used as the mask 8. In case the plug filling jig 6 is to be disposed, it is preferable to dispose the mask 8 on the honeycomb structure 3 before disposing the plug filling jig 6. With this constitution, it is possible to favorably introduce the ceramic slurry 9 into plugged cells 4a.

In FIGS. 2 to 4, the ceramic slurry 9 is placed on a flat plate member 10 and one end 7a of the honeycomb structure 3 is pressed onto the ceramic slurry 9, but the ceramic slurry 9 to be used may be stored in a container having a bottom surface and side surfaces or the like.

The thickness of the ceramic slurry 9 placed on the flat plate member 10 (or the depth of a ceramic slurry if stored in a container or the like) is preferably about one third the depth of the ceramic slurry 9 to be introduced into the plugged cells 4a (hereinafter also referred to as the “plugging depth”).

A member such as a squeezee may be used to level off the ceramic slurry 9 to introduce the ceramic slurry 9 into the plugged cells 4a in a more uniform depth.

As shown in FIG. 1, the honeycomb structure 3 used in the method for manufacturing a plugged honeycomb structure according to this embodiment has a cylindrical body including partition walls 2 formed of a porous body and a large number of cells 4 acting as fluid passageways are divided and formed by the partition walls 2. The honeycomb structure 3 is a relatively fragile structure where the partition walls 2 are comprised a very thin porous body. Thus, it is a general practice to further provide an outer wall 12 as a reinforcing member so as to cover the periphery of the honeycomb structure 3. This improves the mechanical strength of the whole of the honeycomb structure 3 thus effectively preventing possible deformation or damage, or the like while the honeycomb structure 3 is used.

As far as the above conditions are satisfied, a material for a honeycomb structure 3 (partition wall 2, outer wall 12) is not particularly limited. However, the partition wall 2 needs to be porous so that, in general, a ceramic material such as cordierite is preferably used.

The honeycomb structure 3 used in the method for manufacturing a plugged honeycomb structure according to this embodiment may be an undried formed body obtained by forming the above-mentioned ceramic material, a dried body obtained by drying a formed body, or a sintered body obtained by firing a dried body.

The shape of the honeycomb structure 3 is not particularly limited. For example, various shapes such as a cylindrical shape, a rectangular prism shape and a triangular prism shape may be employed. The cell shape (shape of the cell 4 in a plane perpendicular to a passageway) is not particularly limited either. For example, various polygons such as a triangle, a rectangle, a hexagon or an octagon, or a circle, an oblong and an ellipse may be used alone of in combination.

With the method for manufacturing a plugged honeycomb structure according to this embodiment, a method for manufacturing a honeycomb structure 3 is not particularly limited. A preferred example is a method whereby a ceramic clay adjusted to an appropriate viscosity undergoes extrusion molding by using a die having a desired cell shape, a partition wall thickness and a cell density (cell pitch) and is then dried to obtain a honeycomb structure 3. While the pattern of the plugged portions 5 is generally a staggered or checkered pattern but is not limited thereto and may be of a shape of rows or concentric circles.

As shown in FIG. 2, the method for manufacturing a plugged honeycomb structure according to this embodiment comprises disposing a plug filling jig 6 so that it covers the side of the periphery of one end 7a of thus configured honeycomb structure 3 on the side where cells 4a to be plugged (plugged cells) are open and its tip locates being protruded from the end surface of the one end 7a, to separate the end surface of the side of the one end 7a from the surrounding space, and introducing the ceramic slurry 9 serving as plugging parts 5 (see FIG. 1) into the plugged cells 4a of the honeycomb structure 3 to form the plugged portions 5 (see FIG. 1).

A material for the ceramic slurry 9 used in the method for manufacturing a plugged honeycomb structure according to this embodiment is not particularly limited but ceramic powder such as powder obtained by mixing and kneading cordierite powder with a binder, a dispersion medium or the like is preferably used. The type of ceramic powder is preferably the same as that of a material for the partition walls 2 of the honeycomb structure 3 shown in FIG. 1, for example.

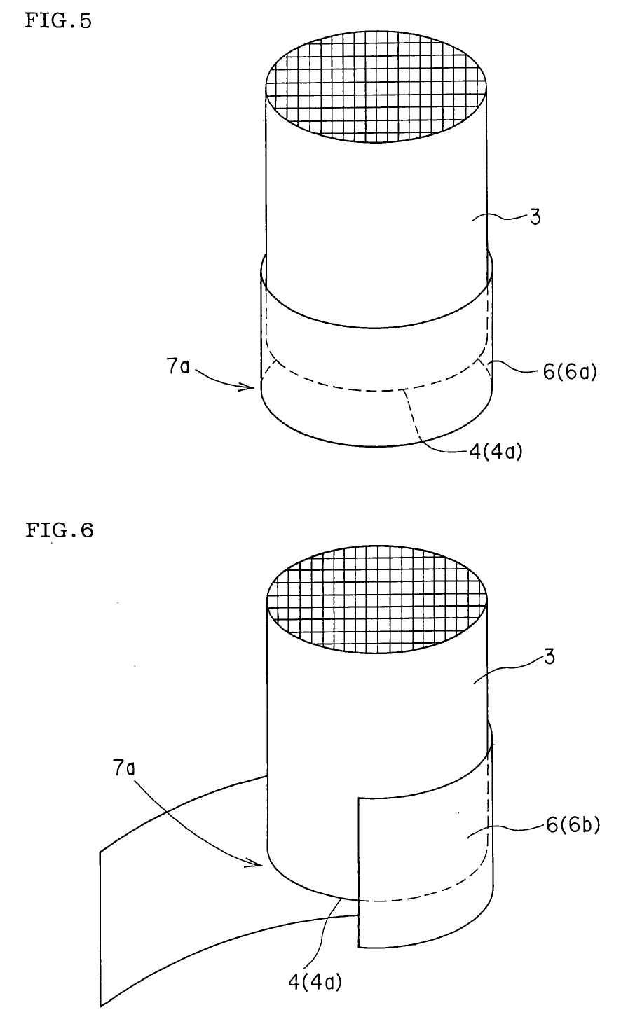

As shown in FIG. 5, in the method for manufacturing a plugged honeycomb structure according to this embodiment, a cylindrical body 6a having elasticity as a plug filling jig 6 is used, and the plug filling jig 6 is disposed at the side of one end 7a of the honeycomb structure 3 by way of the elastic force of the plug filling jig 6. Such a plug filling jig 6 has adhesiveness with the honeycomb structure 3 in the radial direction thereof by way of the elastic force and thus can be readily and reliably disposed at one end 7a of the honeycomb structure 3.

The plug filling jig 6 formed of a cylindrical body 6a having such elasticity may be formed of a rubber known in the conventional technology such as diene rubber or non-diene rubber. For example, preferable exemplary materials for a cylindrical body include natural rubber, synthetic isoprene rubber, butadiene rubber, styrene-butadiene rubber, ethylene-α-olefin copolymer rubber, ethylene-α-olefin-diene copolymer rubber, acrylonitril-butadiene copolymer rubber, chloroprene rubber, butyl rubber halide, silicon rubber, fluoric rubber, urethane rubber, acrylic rubber, and chlorinated polyethylene, or the like.

As shown in FIG. 6, another example of a plug filling jig used in the method for manufacturing a plugged honeycomb structure according to this embodiment is the use of a belt-like body 6b as a plug filling jig 6. By winding the belt-like body 6b around the honeycomb structure 3 at one end 7a, it is possible to dispose the plug filling jig 6 at the side of the one end 7a of the honeycomb structure 3. Such a plug filling jig 6 is used while wound around the honeycomb structure 3 at the side of the one end 7a thus supporting a honeycomb structure 3 having different shape and size. In particular, when the belt-like body 6b is wound around the honeycomb structure 3 at the side of the one end 7a, the belt-like body 6b may be wound by two turns or more. Thus, using the belt-like body 6b with a relatively greater length supports a honeycomb structure 3 in more various shapes and sizes.

The plug filling jig 6 composed of such a belt-like body 6b is preferably made of a material such as a resin, metal, or alloy. The resin belt-like body 6b may be, for example, a polyethylene film about 0.1 mm to 0.5 mm thick or craft paper with a polypropylene resin coated thereon, or the like. The resin belt-like body 6b is wound around the honeycomb structure 3 at the one end 7a and fixed by way of bonding, fusion, adhesive tape or the like.

Similarly, the belt-like body 6b formed of thin metal or alloy may be wound around the honeycomb structure 3 at one end 7a and fixed by way of bonding, fusion, or adhesive tape. In case the belt-like body 6b is formed of a plate spring, it is possible to produce restoring force in the direction the belt-like body 6b is wound around the honeycomb structure 3 and fix the belt-like body 6b to the honeycomb structure 3 at the one end 7a by way of the restoring force. Such a belt-like body 6b may be a stainless plate 0.1 to 0.3 mm thick.

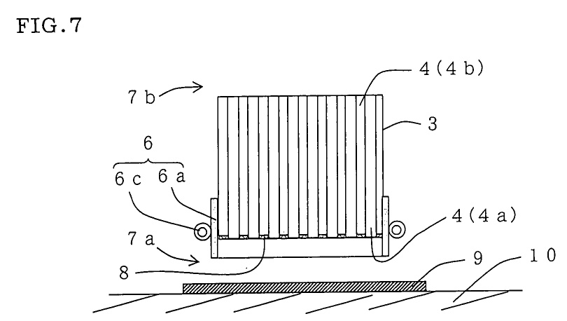

In the method for manufacturing a plugged honeycomb structure according to this embodiment, as shown in FIG. 7, the plug filling jig 6 may include a cylindrical body 6a (cylindrical body 6a in FIG. 7) for separating the end surface of one end 7a from the surrounding space or a belt-like body 6b (see FIG. 6), and a holding part 6c for holding the cylindrical body 6a or the belt-like body 6b (see FIG. 6) at one end 7a of the honeycomb structure 3. By using the plug filling jig 6 including a holding part 6c, the cylindrical body 6a or the belt-like body 6b (see FIG. 6) need not have adhesion to the honeycomb structure 3. For example, the cylindrical body 6a or the belt-like body 6b need not be fixed by using the resin film or the like. FIG. 7 is an explanatory view to illustrate another exemplary process of introducing a ceramic slurry into plugged cells in the method for manufacturing a plugged honeycomb structure according to this embodiment and is also a cross-sectional view of the honeycomb structure, taken parallel to the axial direction.

The holding part 6c is not particularly limited as far as it is capable of holding the cylindrical body 6a or the belt-like body 6b (see FIG. 6) at one end 7a of the honeycomb structure 3. A preferable example is a tube body capable of tightening the peripheral part of the honeycomb structure 3 by compression or decompression, or a coil spring, for example.

In the method for manufacturing a plugged honeycomb structure according to this embodiment, the plug filling jig 6 having rigidity so that a deformation does not occur in the radial direction of the honeycomb structure 3 when the plug filling jig 6 is pressed onto the ceramic slurry 9 is preferably used. That is, the plug filling jig 6 that can withstand the inner pressure of the ceramic slurry 9 when pressed onto the same is preferably used. By using such a plug filling jig 6, it is possible to keep constant the size of an area of the end surface of one end 7a separated from the surrounding space, thereby correctly controlling the amount of the ceramic slurry 9 to be introduced into the plugged cells 4a.

The rigidity to withstand the deformation in the radial direction of the honeycomb structure 3 is a value determined by the composition or viscosity of the ceramic slurry 9 used, size of the honeycomb structure 3, or the like and is thus preferably determined based on respective conditions, arbitrarily.

In the method for manufacturing a plugged honeycomb structure according to this embodiment, it is preferred to press the one end 7a of the honeycomb structure 3 onto the ceramic slurry 9 while causing the tip of the plug filling jig 6 to slide to the end surface of the side of the one end 7a of the honeycomb structure 3, as shown in FIGS. 2 to 4. This finally presses the end surface of the one end 7a of the honeycomb structure 3 onto the flat plate member 10 (such as the bottom surface of a container storing a ceramic slurry 9, if any) on which the ceramic slurry 9 is placed and introduces the whole amount of the ceramic slurry 9 present in the area separated by the plug filling jig 6 into the plugged cells 4a.

In the method for manufacturing a plugged honeycomb structure according to this embodiment, after the ceramic slurry 9 is introduced into the plugged cells 4a at the one end 7a of the honeycomb structure 3, the ceramic slurry 9 may be introduced into the cells 4b at the other end 7b of the honeycomb structure 3 other than the plugged cells 4a at the one end 7a using a similar method. By this, the plugged portions 5 (see FIG. 1) can be alternately formed in the one ends 7a of the cells 4 and in the other ends 7b of the cells 4 of the honeycomb structure 3.

In this way, after the ceramic slurry 9 is introduced into predetermined cells 4, and the ceramic slurry 9 is then dried and fired, a plugged honeycomb structure 1 comprising a cylindrical honeycomb structure 3 including partition walls 2 formed of a porous body and a large number of cells 4 acting as fluid passageways divided and formed by the partition walls 2, and the plugged portions 5 plugging the openings of some of the cells 4 of the honeycomb structure 3, can be manufactured, as shown in FIG. 1. In case the honeycomb structure 3 used when plugging the openings is an unfired formed body or a dried body that has undergone drying alone, the honeycomb structure 3 is dried and fired, along with the ceramic slurry 9 (see FIG. 4) introduced into the plugged cells 4a, to manufacture the plugged honeycomb structure 1.

An embodiment of a method for manufacturing a plugged honeycomb structure according to the second invention will be described. Similar to the embodiment of the first invention (the method for manufacturing a plugged honeycomb structure), the method for manufacturing a plugged honeycomb structure according to this embodiment is a method for manufacturing a plugged honeycomb structure 1 comprising a cylindrical honeycomb structure 3 including partition walls 2 formed of a porous body and a large number of cells 4 acting as fluid passageways divided and formed by the partition walls 2, and plugged portions 5 plugging the openings of some of the cells 4 of the honeycomb structure 3, as shown in FIG. 1.

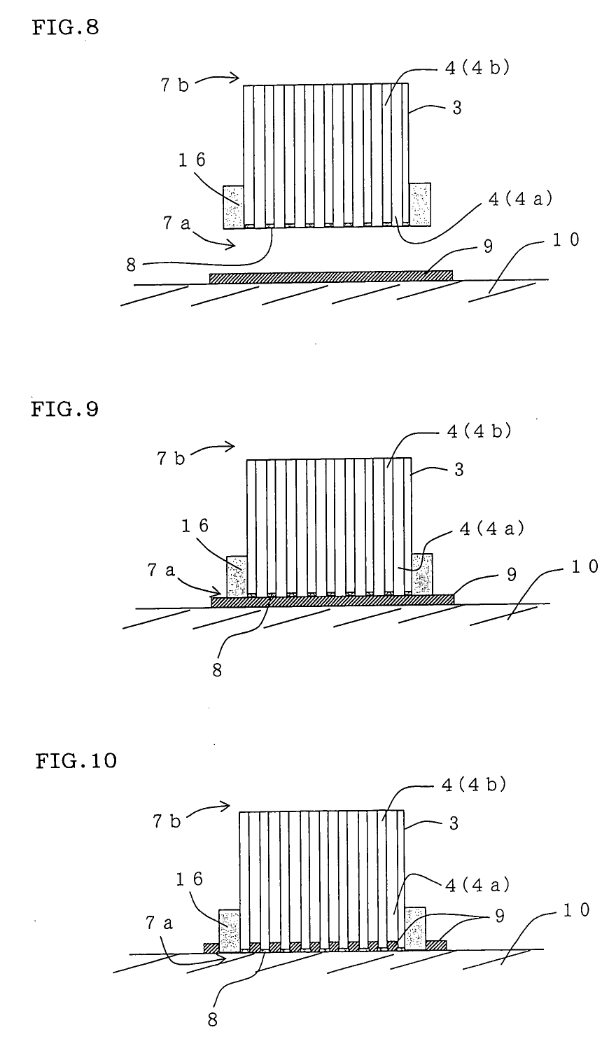

The method for manufacturing a plugged honeycomb structure according to this embodiment is a method for manufacturing a plugged honeycomb structure comprising the steps of arranging a plug filling jig 16 so that it covers the side of the periphery of one end 7a of the honeycomb structure 3 at the side where plugged cells 4a are open and a tip of the plug filling jig 16 locates at the same position as an end surface of the one end 7a, to increase an outer diameter of a portion of the honeycomb structure 3 on the side of the one end 7a, as shown in FIG. 8, and pressing the one end 7a of the honeycomb structure 3 at the side where the plug filling jig 16 is disposed onto a ceramic slurry 9 to thus introduce the ceramic slurry 9 into the plugged cells 4a form a plugged portions 5 (see FIG. 1), as shown in FIGS. 9 and 10. FIGS. 8 to 10 are explanatory views illustrating a process of introducing a ceramic slurry into plugged cells in the method for manufacturing a plugged honeycomb structure according to this embodiment, and are cross-sectional views of the honeycomb structure, taken parallel to the axial direction.

As described in the embodiment of the first invention, a conventional method for manufacturing a plugged honeycomb structure includes a problem that, as shown in FIG. 19, when one end of a honeycomb structure 21 is pressed onto a slurry 29 (ceramic slurry), the slurry 29 to be introduced into plugged cells 24a flows in the direction toward the periphery from one end of the honeycomb structure 21, thus failing to introduce the slurry 29 in a uniform depth into the plugged cells 24a.

Such a problem is attributable to a property that the slurry 29 has fluidity and thus flows toward a portion with smaller resistance to pressure. Thus the influence of the flow of the slurry 29 on the plugging depth is more noticeable at the side of the peripheral portion of the honeycomb structure 21. In the inner side a predetermined distance away from the external wall of the honeycomb structure 21, the influence of the flow of the slurry 29 is smaller so that the slurry 29 is introduced in substantially the same depth.

The method for manufacturing a plugged honeycomb structure according to this embodiment comprises the step of disposing a plug filling jig 16 shown in FIG. 8 on a portion related to the radially outer portion, where in the conventional method, the amount of introduction of a ceramic slurry shows a remarkable decrease that leads to a problem, so as to increase the size of the periphery where the plug filling jig 16 is disposed, so that the influence of the flow of the ceramic slurry 9 on the plugging depth is drastically reduced with respect to the honeycomb structure 3 where the ceramic slurry 9 is introduced. This makes it possible to introduce the ceramic slurry 9 into the plugged cells 4a of the honeycomb structure 3 in a uniform depth.

In the method for manufacturing a plugged honeycomb structure according to this embodiment, a mask 8 having holes formed therein to communicate with the plugged cells 4a is disposed on the end surface of one end 7a of the honeycomb structure 3, so that the ceramic slurry 9 will not be introduced into the cells other than the plugged cells 4a. A mask used in the conventional method for manufacturing a plugged honeycomb structure may be preferably used as the mask 8. In case a plug filling jig 16 is to be arranged, it is preferable to dispose the mask 8 on the honeycomb structure 3 before disposing the plug filling jig 16. With this constitution, it is possible to favorably introduce the ceramic slurry 9 into plugged cells 4a.

The method for manufacturing a plugged honeycomb structure according to this embodiment may preferably use a honeycomb structure 3 and a ceramic slurry 9, similar to those used in the embodiment of the first aspect. The ceramic slurry 9 may be placed on a flat plate member 10 or stored in a container (not shown) or the like, same as the embodiment of the first aspect.

In the method for manufacturing a plugged honeycomb structure according to this embodiment, it is necessary to increase the outer diameter of the honeycomb structure 3 at one end 7a by disposing the plug filling jig 16 and occupy the peripheral portion with the plug filling jig 16 where the amount of introduction of the ceramic slurry 9 is noticeably reduced.

In case the ceramic slurry 9 is introduced, the size of the range where the amount of introduction of the ceramic slurry 9 is noticeably reduced is determined by the plugging depth to be introduced the ceramic slurry 9 or viscosity of the ceramic slurry 9 used and is thus preferably determined based on respective conditions. For example, it is preferred to increase the outer diameter of the honeycomb structure 3 at the side of the one end 7a by a length equivalent to two thirds or more of the plugging depth. While not limitative, the viscosity of the ceramic slurry 9 used on this occasion is, for example, preferably about 150 to 500 dPa·s.

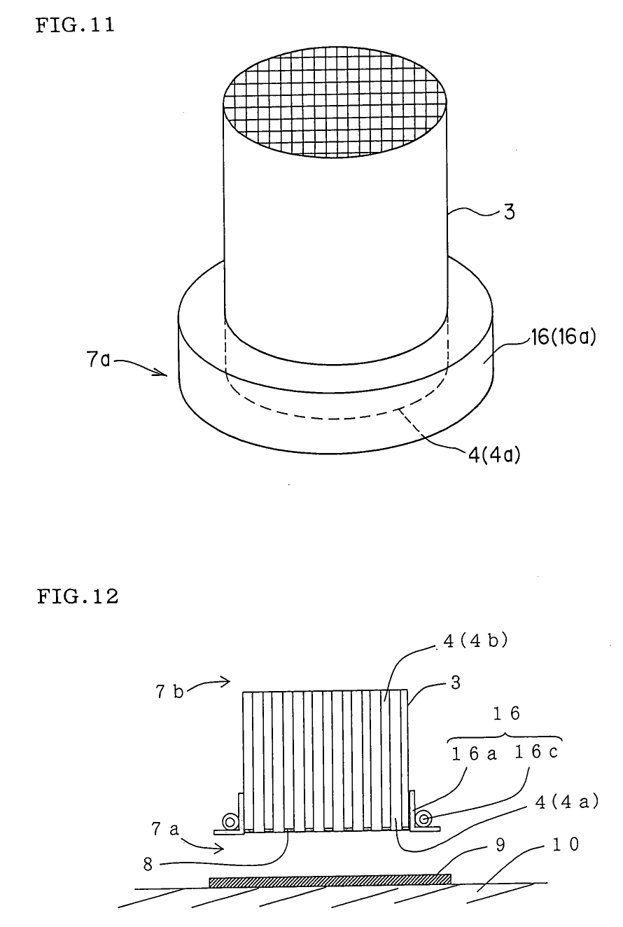

A plug filling jig 16 used in the method for manufacturing a plugged honeycomb structure according to this embodiment may be one formed on a cylindrical body 16a that has an inner diameter corresponding to the size of the periphery of the honeycomb structure 3 where the plugged cell 4 is formed and a thickness capable of increasing the size of the periphery of the honeycomb structure 3 at the side of one end 7a and that can be mounted and fixed on the side of the one end 7a of the honeycomb structure 3, as shown in FIG. 11. In particular, an elastic plug filling jig 16 formed of the cylindrical body 16a is preferably used. Such a plug filling jig 16 has adhesiveness with the honeycomb structure 3 in the radial direction thereof and thus can be readily and reliably disposed at the side of one end 7a of the honeycomb structure 3.

A plug filling jig of a cylindrical body having such elasticity may be formed of a rubber known in the conventional technology such as diene rubber or non-diene rubber. For example, preferable exemplary materials for a cylindrical body include natural rubber, synthetic isoprene rubber, butadiene rubber, styrene-butadiene rubber, ethylene-α-olefin copolymer rubber, ethylene-α-olefin-diene copolymer rubber, acrylonitril-butadiene copolymer rubber, a chloroprene rubber, butyl rubber halide, silicon rubber, fluoric rubber, urethane rubber, acrylic rubber, and chlorinated polyethylene, or the like.

While not shown, in the method for manufacturing a plugged honeycomb structure according to this embodiment, a belt-like body with a relatively greater length as a plug filling jig may be wound around the honeycomb structure at one end more than once to mount and fix the same.

In the method for manufacturing a plugged honeycomb structure according to this embodiment, as shown in FIG. 12, a plug filling jig 16 including a cylindrical body 16a designed to bend in the radial direction at the end surface of the honeycomb structure 3 to increase the outer diameter of the honeycomb structure 3 at one end and a holding part 16c for holding the cylindrical body 16a to one end 7a of the honeycomb structure 3. By using a plug filling jig 16 including a holding part 16c, the cylindrical body 16a need not have adhesiveness to the honeycomb structure 3.

In case the plug filling jig 16 can increase the outer diameter of the honeycomb structure 3 at one end, it is possible to reduce the influence of the flow of the ceramic slurry 9 on the plugging depth. Thus, a cylindrical body 16a designed to bend in the radial direction at the end surface of the honeycomb structure 3 to increase the outer diameter of the honeycomb structure 3 at one end may be used.

Any type of holding part 16c may be used as far as it is capable of holding the cylindrical body 16a at the one end 7a of the honeycomb structure 3. A preferable example is a tube body capable of tightening the peripheral part of the honeycomb structure 3 by compression or decompression, or a coil spring.

In the method for manufacturing a plugged honeycomb structure according to this embodiment, as shown in FIGS. 8 to 10, the plug filling jig 16 is preferably fixed so that it will not move in the axial direction of the honeycomb structure 3 while the one end 7a of the honeycomb structure 3 is pressed onto the ceramic slurry 9. When the plug filling jig 16 moves in the axial direction of the honeycomb structure 3, the change of the flow state of the ceramic slurry 9 is occurred when the one end of the honeycomb structure is pressed onto the ceramic slurry 9 changes, and the ceramic slurry 9 may be difficultly uniformly filled into the plugged cell 4a.

In this way, after the ceramic slurry 9 is introduced into the plugged cells 4a of the honeycomb structure 3, the ceramic slurry 9 is dried and fired to manufacture a plugged honeycomb structure 1 comprising a cylindrical honeycomb structure 3 including partition walls 2 formed of a porous body and a large number of cells 4 acting as fluid passageways are divided and formed by the partition walls 2, and plugged portions 5 plugging the openings of some of the cells 4 of the honeycomb structure 3 as shown in FIG. 1. In case the honeycomb structure 3 used for sealing of openings is an unfired formed body or a dried body that has undergone drying alone, the honeycomb structure 3 is dried and fired, along with the ceramic slurry 9 (see FIG. 10) introduced into the plugged cells 4a, to manufacture a plugged honeycomb structure 1.

In the method for manufacturing a plugged honeycomb structure according to this embodiment also, after the plugging is performed at one end 7a of the honeycomb structure 3, the ceramic slurry 9 may be introduced into the cells 4b at the other end 7b of the honeycomb structure 3 other than the plugged cells 4a at the one end 7a using a similar method as the above-mentioned.

An embodiment of a plug filling jig according to the third invention will be described. The plug filling jig according to this embodiment is one preferably used in the embodiment of the first aspect (the method for manufacturing a plugged honeycomb structure).

The plug filling jig according to this embodiment is one that is disposed at one end 7a of the honeycomb structure 3 where plugged cells 4a are open and that is used to separate the end surface of the one end 7a of the honeycomb structure 3 from the surrounding space and press the one end 7a of the honeycomb structure 3 onto a ceramic slurry 9 (see FIG. 2) thus introducing the ceramic slurry 9 (see FIG. 2) into the plugged cells 4a, the plug filling jig 6 comprising a cylindrical body 6a having an inner diameter corresponding to a size of the periphery of the honeycomb structure 3 having the plugged cells 4a formed therein, wherein the plug filling jig can be mounted and fixed so as to separate the end surface of the side of the one end 7a of the honeycomb structure 3 from the surrounding space, as shown in FIG. 5.

The plug filling jig 6 according to this embodiment can enclose a predetermined amount of the ceramic slurry 9 (see FIG. 2) to be introduced into the plugged cells 4a in a section separated from the surrounding space on the side of the one end 7a. It is thus possible to introduce the ceramic slurry 9 (see FIG. 2) into the plugged cells 4a in a uniform depth when the one end 7a of the honeycomb structure 3 is pressed onto the ceramic slurry 9 (see FIG. 2).

The plug filling jig 6 according to this embodiment is preferably formed of a cylindrical body 6a having elasticity. Such a plug filling jig 6 has adhesiveness with the honeycomb structure 3 in the radial direction thereof and thus can be readily and reliably disposed at the side of one end 7a of the honeycomb structure 3.

A plug filling jig 6 formed of a cylindrical body 6a having such elasticity may be formed of a rubber known in the conventional technology such as a diene rubber or a non-diene rubber. For example, preferable exemplary materials for a cylindrical body include natural rubber, synthetic isoprene rubber, butadiene rubber, styrene-butadiene rubber, ethylene-α-olefin copolymer rubber, ethylene-α-olefin-diene copolymer rubber, acrylonitril-butadiene copolymer rubber, chloroprene rubber, butyl rubber halide, silicon rubber, fluoric rubber, urethane rubber, acrylic rubber, and chlorinated polyethylene, or the like.

The plug filling jig 6 according to this embodiment has the same structure as the plug filling jig formed of a cylindrical body in the embodiment of the first invention and may be used by the method according to the embodiment of the first invention.

An embodiment of a plug filling jig according to the fourth aspect will be described. The plug filling jig according to this embodiment is one preferably used in the embodiment of the first invention (the method for manufacturing a plugged honeycomb structure).

The plug filling jig according to this embodiment is a plug filling jig 6 disposed at one end of a honeycomb structure 3 on the side where plugged cells 4a are open, and used to separate an end surface of the one end 7a of the honeycomb structure 3 from a surrounding space and press the one end 7a of the honeycomb structure 3 onto a ceramic slurry 9 (see FIG. 2) to thus introduce the ceramic slurry 9 into the plugged cells 4a, the plug filling jig 6 comprising a belt-like body 6b having a length greater than a length of a periphery of the honeycomb structure 3 and wound around the periphery of the honeycomb structure 3 to thus allow the plug filling jig 6 to be mounted and fixed so as to separate the end surface of the side of the one end 7a of the honeycomb structure 3 from the surrounding space, as shown in FIG. 6.

The plug filling jig 6 according to this embodiment can enclose a predetermined amount of the ceramic slurry 9 (see FIG. 2) to be introduced into the plugged cells 4a in a section separated from a surrounding space at the side of the one end 7a. It is thus possible to introduce the ceramic slurry 9 (see FIG. 2) into the plugged cells 4a in a uniform depth when the one end 7a of the honeycomb structure 3 is pressed onto the ceramic slurry 9 (see FIG. 2).

The plug filling jig 6 composed of such a belt-like body 6b is preferably made of a material such as resin, metal, or alloy. A resin belt-like body 6a is may be a polyethylene film 0.1 mm to 0.5 mm thick or craft paper with a polypropylene resin coated thereon, or the like. A resin belt-like body 6a is wound around the honeycomb structure 3 at the one end 7a and fixed by way of bonding, fusion, or adhesive tape.

Similarly, the belt-like body 6b formed of thin metal or an alloy may be wound around the honeycomb structure 3 at one end 7a and fixed by way of bonding, fusion, or adhesive tape. In case the belt-like body 6b is formed of a plate spring, it is possible to produce a restoring force in the direction the belt-like body 6b is wound around the honeycomb structure 3 at one end 7a and fix the belt-like body 6b to the honeycomb structure 3 at the one end 7a by way of the restoring force. Such a belt-like body 6b may be a stainless plate 0.1 to 0.3 mm thick. The plug filling jig 6 according to this embodiment has the same structure as the plug filling jig formed of a belt-like body in the embodiment of the first aspect and may be used by the method according to the embodiment of the first aspect.

An embodiment of a plug filling jig according to the fifth aspect will be described. The plug filling jig according to this embodiment is one preferably used in the embodiment of the second aspect (the method for manufacturing a plugged honeycomb structure).

The plug filling jig according to this embodiment is a plug filling jig 16 disposed at one end 7a of a honeycomb structure 3 on the side where plugged cells 4a are open, the plug filling jig used to increase the outer diameter of the honeycomb structure 3 at the one end 7a and press the one end 7a of the honeycomb structure 3 onto a ceramic slurry 9 (see FIG. 8) to thus introduce the ceramic slurry 9 (see FIG. 8) into the plugged cells 4a, the plug filling jig 16 comprising a cylindrical body 16a having an inner diameter corresponding to a size of a periphery of the honeycomb structure 3 having the plugged cells 4a formed therein and a thickness capable of increasing an outer diameter of the honeycomb structure 3 at the side of the one end 7a, wherein the plug filling jig 16 can be mounted and fixed on the side of the one end 7a of the honeycomb structure 3, as shown in FIG. 11.

By disposing the plug filling jig 16 according to this embodiment at the side of one end 7a of the honeycomb structure 3, it is possible to increase the outer diameter of the honeycomb structure 3 at the side of the one end 7a with the plug filling jig 16 and occupy a portion related to the side of the periphery, where in the conventional method, the amount of introduction of a ceramic slurry is noticeably reduced leading to a problem. In this way, the influence of the flow of the ceramic slurry 9 (see FIG. 8) on the plugging depth is drastically reduced with the honeycomb structure 3 positioned inside from the external side surface of the plug filling jig 16 by its thickness. This allows the ceramic slurry 9 (see FIG. 8) to be introduced into the plugged cell 4a in a uniform depth when the one end 7a of the honeycomb structure 3 is pressed onto the ceramic slurry 9 (see FIG. 8).

The plug filling jig 16 according to this embodiment has a same structure as the plug filling jig according to the embodiment of the second invention and can be used by the method according to the embodiment of the second invention. The plug filling jig 16 according to this embodiment may include a cylindrical body 16a designed to bend in the radial direction at the end surface of the honeycomb structure 3 to increase the outer diameter of the honeycomb structure 3 at the side of one end and a holding part 6c for holding the cylindrical body 16a to one end 7a of the honeycomb structure 3 as shown in FIG. 12.

### EXAMPLES

The invention will be described by way of the following examples although the invention is not limited thereto.

### Example 1

In this example, a cylindrical honeycomb structure including partition walls formed of a porous body where a large number of cells acting as fluid passageways were divided and formed by the partition walls was provided as a honeycomb structure to be used. The honeycomb structure was comprised cordierite and had a shape of a cylinder whose end surface was a circle 250 mm across, a rectangular cell shape, a partition wall thickness of 0.3 mm (12 mil), and a cell density of 46.5 cells/cm² (300 cells/square inch). On the diagonal line on the end surface of the honeycomb structure were 85 cells. 1 mil is equal to one thousandth of an inch and is approximately 0.025 mm.

The honeycomb structure was manufactured by adjusting a clay to an appropriate viscosity, performing extrusion molding on the clay by using a die having the above cell shape, partition wall thickness and cell density, drying the resulting green body, and cutting both end surfaces to provide smooth surfaces.

On such a honeycomb structure, a plug filling jig formed of a cylindrical body of a natural rubber having a thickness of 8 mm was disposed so as to cover the side of the periphery of one end of the honeycomb structure on the side where plugged cells were open and its tip locates being protruded from the end surface of the one end, and the end surface of the side of the one end was separated from the surrounding space, and the one end of the honeycomb structure where the plug filling jig was disposed was pressed onto a ceramic slurry to thus introduce the ceramic slurry into the plugged cells. In this example, the target depth of the ceramic slurry to be introduced into each plugged cell was 5 mm.

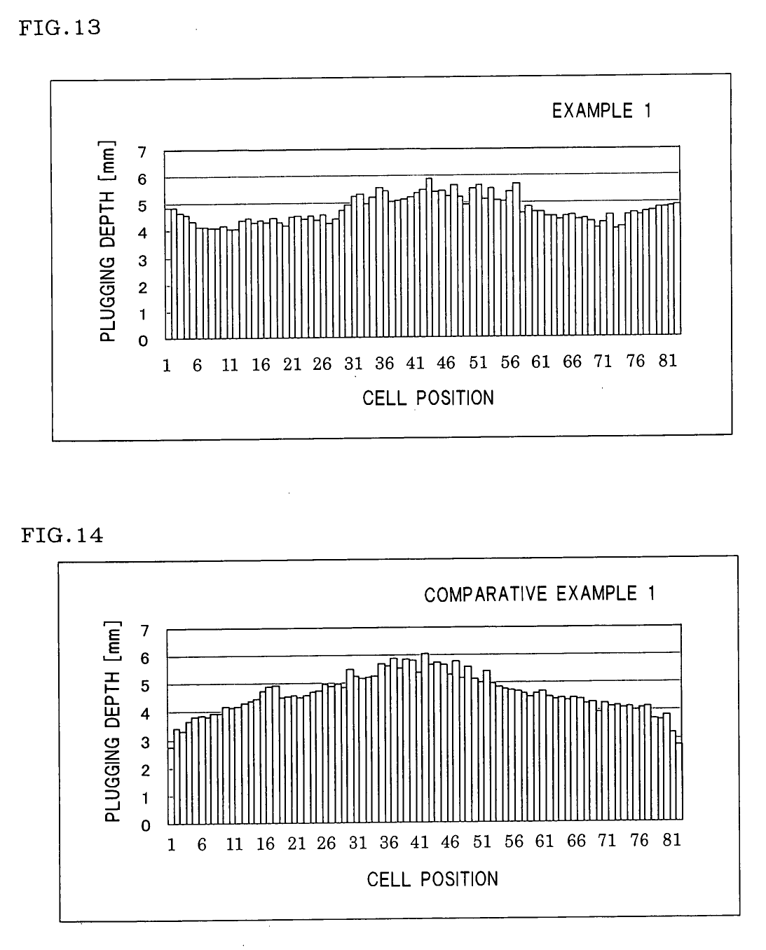

After the ceramic slurry was introduced into plugged cells, the depth (hereinafter referred to as the “plugging depth”) of the ceramic slurry introduced into each plugged cell was measured for 85 cells on the diagonal line of the end surface. FIG. 13 is a graph showing each plugging depth in the 85 cells on the diagonal line of the end surface. In FIG. 13, vertical axis shows a plugging depth (mm) while horizontal axis shows the position of the 85 cells on the diagonal line of the end surface. Table 1 shows the plugging depth (mm) in the 10 cells at the side of the periphery (cell positions 1 to 10 and 76 to 85 in FIG. 13).

TABLE 1

Plugging depth (mm)

| Cell position | Example 1 | Comparative Example 1 |
|---|---|---|
| 1 | 4.8 | 2.7 |
| 2 | 4.8 | 3.3 |
| 3 | 4.6 | 3.2 |
| 4 | 4.5 | 3.5 |
| 5 | 4.2 | 3.7 |
| 6 | 4.1 | 3.8 |
| 7 | 4.1 | 3.6 |
| 8 | 4.0 | 3.9 |
| 9 | 4.0 | 3.9 |
| 10 | 4.1 | 4.2 |
| 76 | 4.1 | 4.1 |
| 77 | 4.5 | 4.2 |
| 78 | 4.6 | 3.9 |
| 79 | 4.5 | 4.1 |
| 80 | 4.6 | 4.2 |
| 81 | 4.6 | 4.7 |
| 82 | 4.7 | 4.6 |
| 83 | 4.7 | 4.8 |
| 84 | 4.8 | 3.2 |
| 85 | 4.9 | 2.7 |

### Comparative Example 1

A honeycomb structure similar to one used in Example 1 was pressed onto a ceramic slurry while a plug filling jig was not disposed on the honeycomb structure to introduce the ceramic slurry into plugged cells. After the ceramic slurry was introduced into plugged cells in this way, each plugging depth was measured for 85 cells on the diagonal line of the end surface. FIG. 14 is a graph showing each plugging depth in the 85 cells on the diagonal line of the end surface. In FIG. 14, vertical axis shows a plugging depth (mm) while horizontal axis shows the positions of the 85 cells on the diagonal line of the end surface. Table 1 shows the plugging depth (mm) in the 10 cells at the side of the periphery (cell positions 1 to 10 and 76 to 85 in FIG. 14).

As shown in FIG. 13, FIG. 14 and Table 1, the plugged honeycomb structure obtained by Comparative Example 1 had the plugging depth of each of the 10 cells at the side of each periphery reduced. The plugged honeycomb structure obtained by Example 1 showed no reduction in the plugging depth of each of the 10 cells at the side of the periphery. The reason the plugging depth at the side of the periphery was somewhat greater is because the ceramic slurry pushed away by the thickness of the plug filling jig had been introduced into the plugged cells at the side of the periphery.

### Example 2

In this example, a cylindrical honeycomb structure including partition walls formed of a porous body and a large number of cells acting as fluid passageways divided and formed by the partition walls was provided as a honeycomb structure to be used. The honeycomb structure was comprised cordierite and had a shape of a cylinder whose end surface was a circle 210 mm across, a rectangular cell shape, a partition wall thickness of 0.3 mm (12 mil), and a cell density of 46.5 cells/cm² (300 cells/square inch). On the diagonal line on the end surface of the honeycomb structure were 70 cells.

The honeycomb structure was manufactured by adjusting a clay to an appropriate viscosity, performing extrusion molding on the clay by using a die having the above cell shape, partition wall thickness and cell density, drying the resulting green body, and cutting both end surfaces to provide smooth surfaces.

On such a honeycomb structure, a plug filling jig formed of a cylindrical body of a natural rubber having a thickness of 4 mm was disposed so as to cover the side of the periphery of one end on the side where plugged cells were open and its tip locates at the same position as the end surface of the one end, the outer diameter of the honeycomb structure at the side of the one end was increased, and the one end of the honeycomb structure where the plug filling jig was disposed was pressed onto a ceramic slurry thus introducing the ceramic slurry into the plugged cell. In this example, the target depth of the ceramic slurry to be introduced into each plugged cell was 10 mm.

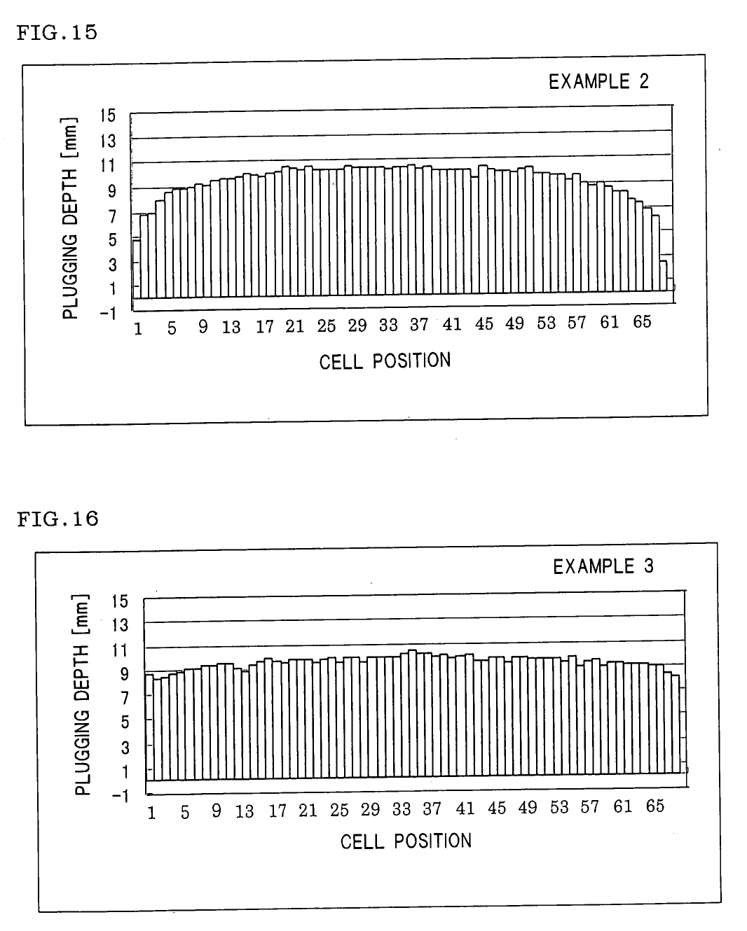

After the ceramic slurry was introduced into plugged cells, each plugging depth was measured for 70 cells on the diagonal line of the end surface. FIG. 15 is a graph showing each plugging depth in the 70 cells on the diagonal line of the end surface. In FIG. 15, vertical axis shows a plugging depth (mm) while horizontal axis shows the positions of the 70 cells on the diagonal line of the end surface. Table 2 shows the plugging depth (mm) in the 10 cells at the side of the periphery (cell positions 1 to 10 and 61 to 70 in FIG. 15).

TABLE 2

| | Plugging depth (mm) | | |
|---|---|---|---|
| Cell position | Example 2 | Example 3 | Comparative Example 2 |
| 1 | 4.8 | 8.8 | 4.0 |
| 2 | 6.9 | 8.4 | 6.0 |
| 3 | 7.0 | 8.7 | 7.1 |
| 4 | 8.0 | 8.8 | 7.3 |
| 5 | 8.5 | 8.9 | 7.8 |
| 6 | 8.9 | 9.0 | 8.5 |
| 7 | 8.9 | 9.0 | 8.0 |
| 8 | 9.0 | 9.3 | 8.2 |
| 9 | 10.2 | 9.3 | 8.4 |
| 10 | 9.0 | 9.5 | 9.0 |
| 61 | 8.9 | 9.2 | 8.5 |
| 62 | 9.0 | 9.5 | 8.1 |
| 63 | 8.8 | 9.0 | 7.7 |
| 64 | 8.2 | 9.2 | 7.9 |
| 65 | 8.2 | 9.2 | 7.1 |
| 66 | 7.5 | 9.2 | 7.0 |
| 67 | 7.3 | 9.0 | 6.4 |
| 68 | 6.9 | 9.0 | 5.7 |
| 69 | 6.0 | 8.7 | 5.0 |
| 70 | 2.5 | 8.0 | 3.0 |

### Example 3

On a honeycomb structure similar to that in Example 2, a plug filling jig formed of a cylindrical body of a natural rubber having a thickness of 8 mm was disposed. By using the same method as that in Example 2, a ceramic slurry was introduced into plugged cells. After the ceramic slurry was introduced into plugged cells, each plugging depth was measured for 70 cells on the diagonal line of the end surface. FIG. 16 is a graph showing each plugging depth in the 70 cells on the diagonal line of the end surface. In FIG. 16, vertical axis shows a plugging depth (mm) while horizontal axis shows the positions of the 70 cells on the diagonal line of the end surface. Table 2 shows the plugging depth (mm) in the 10 cells at the side of the periphery (cell positions 1 to 10 and 61 to 70 in FIG. 16).

### Comparative Example 2

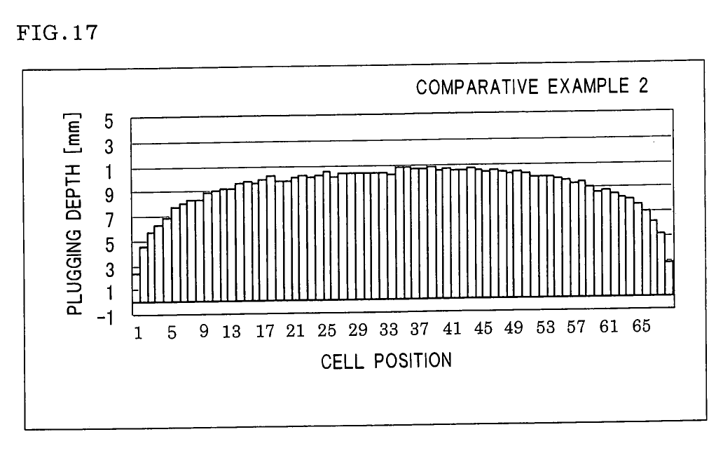

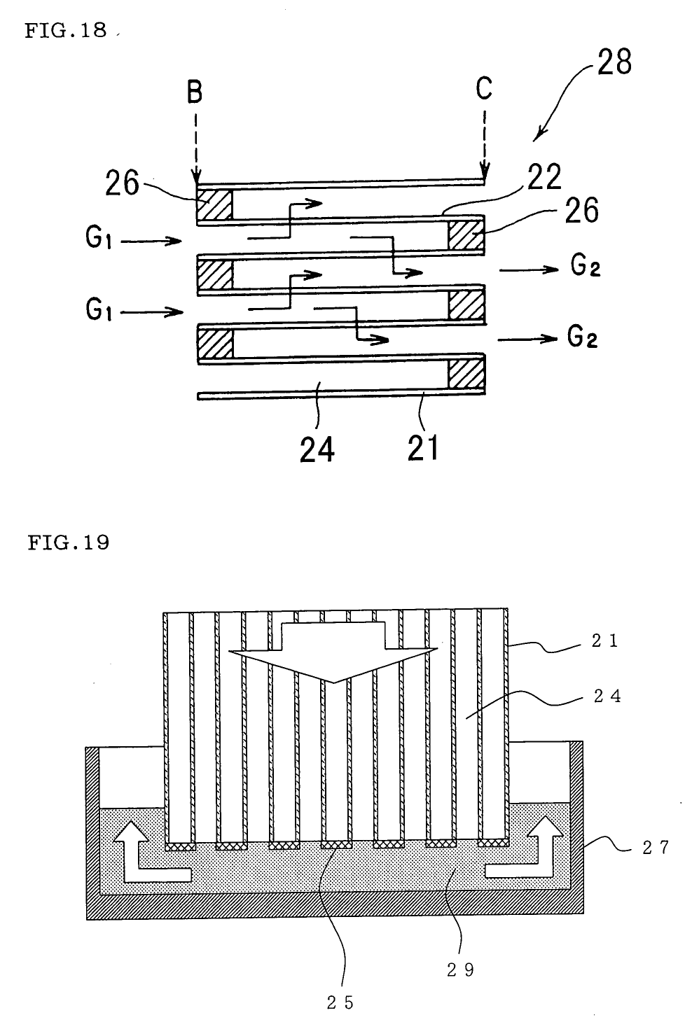

A honeycomb structure similar to one used in Example 2 was pressed onto a ceramic slurry while a plug filling jig was not disposed on the honeycomb structure to introduce the ceramic slurry into plugged cells. After the ceramic slurry was introduced into plugged cells in this way, each plugging depth was measured for 70 cells on the diagonal line of the end surface. FIG. 17 is a graph showing each plugging depth in the 70 cells on the diagonal line of the end surface. In FIG. 17, vertical axis shows a plugging depth (mm) while horizontal axis shows the positions of the 70 cells on the diagonal line of the end surface. Table 2 shows the plugging depth (mm) in the 10 cells at the side of the periphery (cell positions 1 to 10 and 61 to 70 in FIG. 17).

As shown in FIGS. 15, 16 and 17 and Table 2, the plugged honeycomb structure obtained by Comparative Example 2 had the plugging depth of each of the 10 cells at the side of the periphery reduced. The plugged honeycomb structure obtained by Example 2 showed smaller reduction in the plugging depth of each of the 10 cells at the side of the periphery. The plugged honeycomb structure obtained by Example 3 showed almost no reduction in the plugging depth of each of the 10 cells at the side of the periphery. Thus, extremely favorable results were obtained.

The method for manufacturing a plugged honeycomb structure according to the present invention may be used as a method for manufacturing a plugged honeycomb structure preferably used as a filter for trapping and purifying particulates contained in the exhaust gas emitted from internal-combustion engines such as a diesel engine or various types of combustion equipment. In particular, the method for manufacturing a plugged honeycomb structure according to the invention provides a plugged honeycomb structure in which the plugging depth is uniform.

The plug filling jig according to the present invention is preferably used in the method for manufacturing a plugged honeycomb structure according to the invention.

What is claimed is:

1. A method for manufacturing a plugged honeycomb structure comprising a cylindrical honeycomb structure including partition walls formed of a porous body and a large number of cells acting as fluid passageways divided and formed by said partition walls, and plugged portions plugging openings of some of said cells of said honeycomb structure, the method comprising the step of pressing one end of said honeycomb structure at the side where a plug filling jig is disposed onto a ceramic slurry to thus introduce said ceramic slurry into cells to be plugged (plugged cells) to form said plugged portions,
wherein said plug filling jig is disposed by one of the steps selected from the step (A) and step (B) specified below:
step (A)
disposing said plug filling jig so that it covers the side of a periphery of said one end of said honeycomb structure at the side where plugged cells are open and a tip of said plug filling jig locates being protruded from an end surface of the side of said one end, to separate the end surface of the side of said one end from a surrounding space; and
step (B)
disposing said plug filling jig so that it covers the side of a periphery of said one end of said honeycomb structure on the side where plugged cells are open and a tip of said plug filling jig locates at the same position as an end surface of said one end, to increase an outer diameter of a portion of said honeycomb structure increase at the side of said one end.

2. The method for manufacturing a plugged honeycomb structure according to claim 1, wherein said disposing said plug filling jig is carried by the step (A).

3. The method for manufacturing a plugged honeycomb structure according to claim 1, wherein a cylindrical body having elasticity is used as said plug filling jig and said plug filling jig is disposed at the side of said one end of said honeycomb structure by way of the elastic force of said plug filling jig.

4. The method for manufacturing a plugged honeycomb structure according to claim 1, wherein a belt-like body is used as said plug filling jig and said belt-like body is wound around said honeycomb structure at the side of said one end to arrange said plug filling jig at the side of said one end of said honeycomb structure.

5. The method for manufacturing a plugged honeycomb structure according to claim 1, wherein a material having rigidity so that a deformation in the radial direction of said honeycomb structure does not occur when it is pressed onto said ceramic slurry is used as said plug filling jig.

6. The method for manufacturing a plugged honeycomb structure according to claim 1, wherein said one end of said honeycomb structure is pressed onto the ceramic slurry while causing the tip of said plug filling jig to slide to the end surface of the side of said one end of said honeycomb structure.

7. The method for manufacturing a plugged honeycomb structure according to claim 1, wherein said disposing said plug filling jig is carried by the step (B).

8. The method for manufacturing a plugged honeycomb structure according to claim 7, wherein said plug filling jig is disposed at said one end to increase the outer diameter of a portion of said honeycomb structure at the side of said one end by a length equivalent to two thirds or more of the plugging depth of said slurry to be introduced into said plugged cells.

9. The method for manufacturing a plugged honeycomb structure according to claim 1, wherein said plug filling jig is disposed after a mask having holes capable of forming therein to communicate with said plugged cells is disposed.

10. The method for manufacturing a plugged honeycomb structure according to claim 1, wherein an unfired honeycomb structure is used as said honeycomb structure, and said plugged honeycomb structure is obtained by filling said plugged cells with said ceramic slurry, and then drying and firing it.

11. A plug filling jig disposed at one end of a honeycomb structure at the side where plugged cells are open, and used to separate an end surface of the side of said one end of said honeycomb structure from a surrounding space and press said one end of said honeycomb structure onto a ceramic slurry to thus introduce said ceramic slurry into said plugged cells, said plug filling jig comprising:
a cylindrical body having an inner diameter corresponding to a size of a periphery of said honeycomb structure having said plugged cells formed therein, wherein said plug filling jig can be mounted and fixed so as to separate the end surface of the side of said one end of said honeycomb structure from the surrounding space.

12. A plug filling jig disposed at one end of a honeycomb structure at the side where plugged cells are open, and used to separate an end surface of said one end of said honeycomb structure from a surrounding space and press said one end of said honeycomb structure onto a ceramic slurry to thus introduce said ceramic slurry into said plugged cells, said plug filling jig comprising:
a belt-like body having a length greater than a length of a periphery of said honeycomb structure and wound around the periphery of said honeycomb structure to thus allow said plug filling jig to be mounted and fixed so as to separate the end surface of the side of said one end of said honeycomb structure from a surrounding space.

13. A plug filling jig disposed at one end of a honeycomb structure at the side where plugged cells are open, and used to increase an outer diameter of a portion of said honeycomb structure at the side of said one end and press said one end of said honeycomb structure onto a ceramic slurry to thus introduce said ceramic slurry into said plugged cells, said plug filling jig comprising:
a cylindrical body having an inner diameter corresponding to a size of a periphery of said honeycomb structure having said cells to be plugged formed therein and a thickness capable of increasing an outer diameter of a portion of said honeycomb structure at the side of said one end, wherein said plug filling jig can be mounted and fixed on the side of said one end of said honeycomb structure.
